(19) United States
(12) Patent Application Publication
(10) Pub. No.: US 2014/0240139 A1
(43) Pub. Date: Aug. 28, 2014

(54) PORTABLE MESSAGE DEVICE

(71) Applicant: Marketing Displays, Inc., Farmington Hills, MI (US)

(72) Inventors: Troy R. Tapley, Wixom, MI (US); Christopher M. Larsen, Farmington Hills, MI (US); James Church, Northville, MI (US)

(73) Assignee: Marketing Displays, Inc., Farmington Hills, MI (US)

(21) Appl. No.: 14/186,455

(22) Filed: Feb. 21, 2014

Related U.S. Application Data
(60) Provisional application No. 61/767,927, filed on Feb. 22, 2013.

(51) Int. Cl. G08B 5/36; G09B 21/00

(52) U.S. Cl. CPC G08B 5/36; G09B 21/00
USPC 340/815.4

(57) ABSTRACT

A portable message device includes a base having at least one wheel providing portability for the portable message device, and a base access panel which in an open position provides access to an internal base cavity. A communication feature includes a message portion providing a predetermined message saved in a memory. A sensor provides indication of the proximity of a person to the portable message device. A processor is connected to the sensor and the memory. The processor actuates the communication feature upon sensing the proximity of the person. A power source positioned substantially within the internal base cavity provides electrical power to operate the communication feature and the sensor, the power source being accessible by opening the base access panel.

### CROSS-REFERENCE TO RELATED APPLICATIONS

This application claims the benefit of U.S. Provisional Application No. 61/767,927, filed on Feb. 22, 2013. The entire disclosure of the above application is incorporated herein by reference.

### FIELD

The present disclosure relates to portable message devices and more particularly to stands for portable message devices.

### BACKGROUND

This section provides background information related to the present disclosure which is not necessarily prior art.

The Americans with Disabilities Act (ADA), in particular Title III, requires that a public accommodation must provide auxiliary aids and services when they are necessary to ensure effective communication with individuals with hearing, vision, or speech impairments. This can include the use, design and placement of signs and other message devices. These requirements can include in particular signs and other message devices for the hearing, speech and/or sight impaired to alert people with disabilities to the presence of temporary construction areas, and alert people of possible riding or driving roadway changes, or of pedestrian crosswalk pathway changes. These message devices can commonly include sensors that remotely identify the presence of a person or object within a specific range or field of view of the device, a voice or sound speaker that can play a pre-recorded message, and/or an electronically controlled message board that visually displays a specific instruction or message concerning the area of concern, and flashing lights.

Due to the often temporary use of such signs and other message devices, limited temporary power required for operation of the sign is commonly provided in the form of one or more batteries which are commonly positioned in the sign post, the sign body itself or external of the message device, thereby providing proximate access for electrical connections, but positioning the batteries above a center of gravity of the sign assembly.

### SUMMARY

This section provides a general summary of the disclosure, and is not a comprehensive disclosure of its full scope or all of its features.

According to several aspects, a portable message device includes a base. A communication feature is provided requiring electrical power. A power source positioned substantially within the base provides electrical power to operate the communication feature.

According to other aspects, a portable message device includes a base having at least one wheel providing portability for the portable message device, and a base access panel which in an open position provides access to an internal base cavity. A communication feature includes a screen displaying a predetermined message saved in a memory. A sensor provided on the post member or in the base provides indication of the proximity of a person to the portable message device. A processor is connected to the sensor and the memory. The processor actuates the communication feature upon sensing the proximity of the person. A power source positioned substantially within the internal base cavity provides electrical power to operate the communication feature and the sensor, the power source being accessible by opening the base access panel.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a front left perspective view of a portable message device of the present disclosure;

FIG. 2 is an exploded assembly view of the portable message device of FIG. 1;

FIG. 3 is a rear elevational view of the portable message device of FIG. 1;

FIG. 4 is a rear perspective view of the base portion of the portable message device of FIG. 1 with a removable cover in an open position;

FIG. 5 is a left side elevational view of the portable message device of FIG. 1;

FIG. 6 is a right side elevational view of the portable message device of FIG. 1; and

FIG. 7 is a front left perspective view of another aspect of a portable message device of the present disclosure.

FIG. 8 is a perspective view of another aspect of a portable message device of the present disclosure.

Corresponding reference numerals indicate corresponding parts throughout the several views of the drawings.

### DETAILED DESCRIPTION

Example embodiments will now be described more fully with reference to the accompanying drawings.

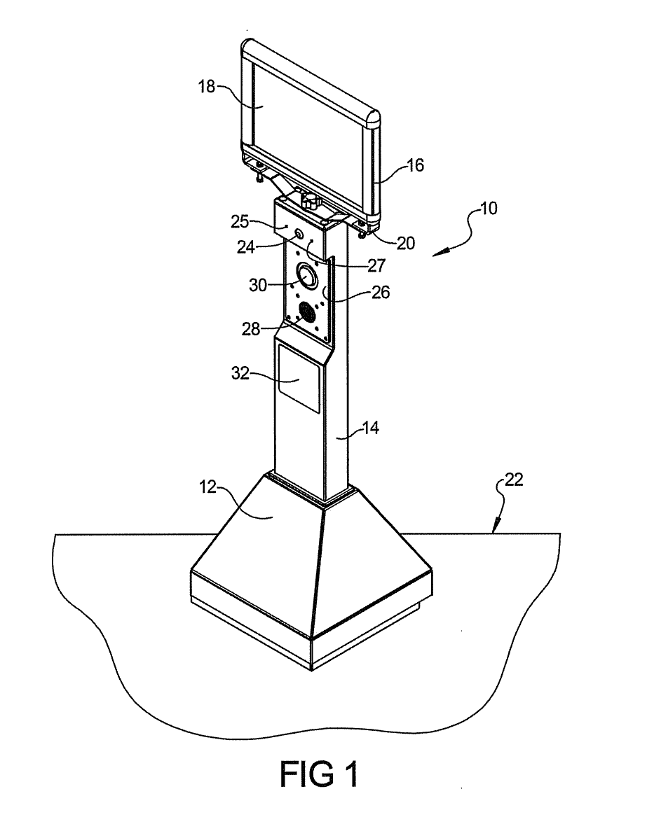

Referring to FIG. 1, a portable message device 10 includes a base 12 which supports a post member 14. At least one communication feature 16 is provided with portable message device 10. According to several aspects, communication feature 16 is a combination of a sign frame/sign screen 18, the sign frame/sign screen 18 being connected to the post member 14. Messages, such as instructions for pedestrian crosswalks, hazardous area conditions, and the like, can be electronically displayed by sign frame/sign screen 18. Sign frame/sign screen 18 can also include a fixed or permanent sign at the user's discretion. Sign frame/sign screen 18 is connected to post member 14 using a sign mounting unit 20.

The base 12 is supported on a ground surface 22, which is preferably a planar surface, thereby positioning post member 14 in a substantially normal orientation with respect to ground surface 22. The base 12 may be temporarily anchored to the ground surface, as described below, to reduce potential theft and damage during extended use, while still providing portability. The base 12 and post member 14 are sized to locate a plurality of components within ease of viewing and operation by a person approaching portable message device 10. These include but are not limited to an actuation switch 30 which for example can be a biased push button actuated by a user approaching portable message device 10. Operation of actuation switch 30 can display information on sign frame and sign screen 18 or actuate a traffic signal for example for use during crossing of a pedestrian crosswalk, and can activate an audible message and/or flashing lights or other communication devices.

A removable panel 26 is connected to post member 14. According to several aspects, communication feature 16 can include a speaker 28 connected to removable panel 26, through which an on-site recorded message is replayed. The speaker 28 is actuated when the person approaches within a predetermined distance of a sensor 24, provided on post member 14, removable panel 26, or on base 12. The sensor 24 can be any of a plurality of sensor types, including a proximity sensor, a motion sensor, a thermal sensor such as an infra-red sensor and the like. Post member 14 can further include other sensors, such as an ambient light sensor 25, or indicators, such as battery low indicator light 27. Post member 14 can further include an ADA handicap sign 32 providing the International Universal Accessability Symbol plainly visible to people approaching portable message device 10.

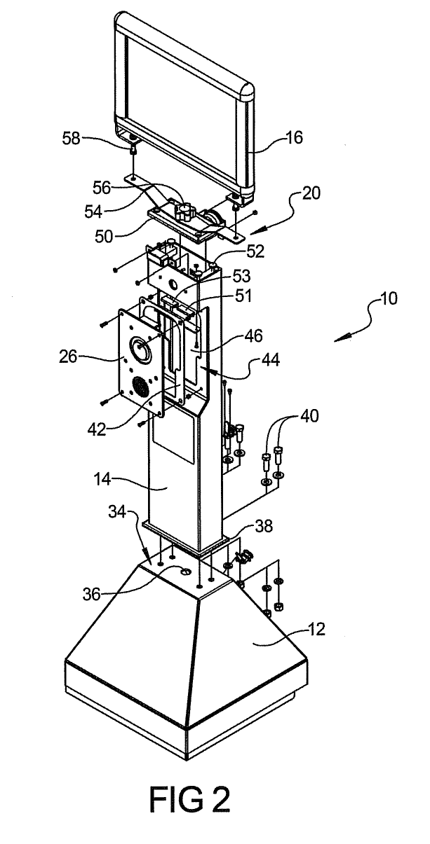

Referring to FIG. 2 and again to FIG. 1, portable message device 10 also includes a planar mount surface 34 defining an upper planar surface of base 12 which is oriented parallel to ground surface 22. A services aperture 36 is provided in planar mount surface 34 for extension of wires and other components traversing between base 12 and sign frame/sign screen 18. The post member 14 includes a lower support plate 38 which is positioned in direct contact with and fastened to planar mount surface 34 using a plurality of fasteners 40. The removable panel 26 is connected to post member 14 having a seal member 42 positioned between the removable panel 26 and a forward face 44 of post member 14. The seal member 42 provides a weather-resistant seal to keep dirt, dust, and moisture out of a post cavity 46.

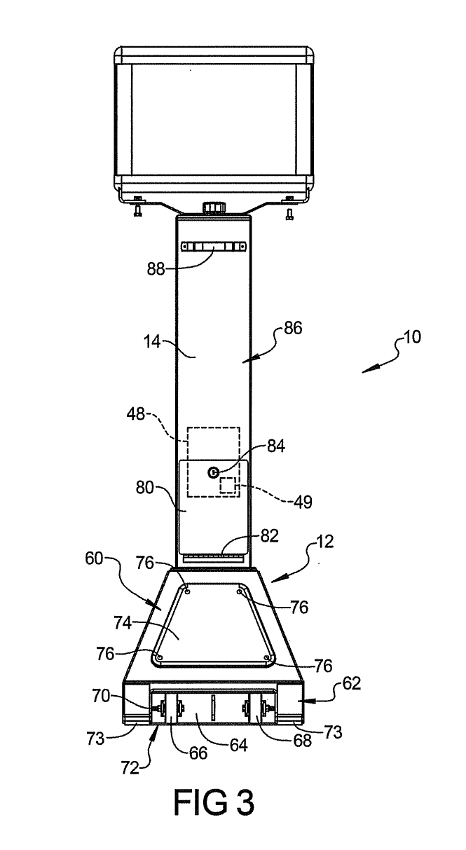

Post cavity 46 provides space for components such as an electronic processor 48 used to control the operation of sign screen 18. Processor 48 is connected to the various components, such as sensor 24, speaker 28, and actuation switch 30, ambient light sensor 25, as well as the sign screen 18. Processor 48 therefore receives signals from the sensor 24 and/or the actuation switch 30 and provides output for either the sign frame/sign screen 18 and/or the speaker 28. An on-site recorded message can be saved in a memory 49 which is also in communication with processor 48. A card or circuit board containing processor 48 and memory 49 can be located at any location, including external of the base 12, such as in the sign frame/sign screen 18 or in the post member 14 including behind removable panel 26. The card or circuit board can beneficially be located within a portion of the post cavity 46 of post member 14 accessible by opening a post access door 80 which is shown and described in reference to FIG. 3. The card or circuit board containing processor 48 and memory 49 can also be located within base 12 to further modularize base 12.

Post cavity 46 can further provide space for lights 51 and 53, ambient light sensor 25, and battery low indicator light 27. The lights may be of many types, but LED lights are preferred to reduce maintenance and power requirements. The ambient light sensor 25 detects when ambient light near the portable message device 10 is below a threshold. The ambient light sensor 25 may then signal the lights 51 and 53 to turn on to ease viewing and operation by a person approaching the portable message device 10. The battery low indicator light 27 may indicate when more power may be required, as described below.

An upper support plate 50 of sign mounting unit 20 is connected to the post member 14 using a plurality of fasteners 52. The sign mounting unit 20 also includes a sign support bracket 54 which is rotatable with respect to upper support plate 50 so that sign frame/sign screen 18 can be oriented as desired regardless of the orientation of base 12. A hand operable nut 56 allows the rotated position of sign support bracket 54 and thereby the orientation of sign frame 16 and sign frame/sign screen 18 to be controlled by rotation to a desired orientation followed by hand tightening of the hand operable nut 56. The sign frame/sign screen 18 is connected to the sign support bracket 54 using a plurality of fasteners 58.

Referring to FIG. 3 and again to FIGS. 1-2, the base 12 can have a geometric shape such as, but not limited to, a pyramid shape shown. Other shapes can also be used for base 12 as required by other components, such as an array 114, or conditions near the portable message device 10. Other shapes can be any geometric shape desired or a rounded or bulbous shape provided by a molding operation. Base 12 can be provided of multiple different materials including but not limited to metals such as aluminum, and polymeric materials suitable for molding. Base 12 includes a base rear wall 60 which slopes downwardly and outwardly from the post member 14 to a base rear edge 62. According to several aspects, base rear edge 62 is oriented normal to the ground surface 22 upon which base 12 is positioned. A wheel cavity 64 is created through base rear edge 62. At least one wheel, and according to several aspects, a plurality of wheels, including a first wheel 66 and a second wheel 68, are positioned at least partially in wheel cavity 64. The first and second wheels 66, 68 are used for manual transportation of portable message device 10. Each of the first and second wheels 66, 68 are supported on an axle, such as a wheel axle 70 or caster connected to the base 12.

In the upright position of portable message device 10 shown, a base bottom surface 72 is positioned below a lowermost surface of either of first or second wheels 66, 68. This positioning of base bottom surface 72 prevents ground contact between either of the first or second wheels 66, 68 when the portable message device 10 is in its upright position and with the base bottom surface 72 in direct contact with the ground surface. Base bottom surface 72 thereby provides a frictional contact surface to prevent sliding of portable message device 10 when in its desired location. The base bottom surface 72 may further have holes accessible from within the base cavity for fasteners to temporarily anchor the portable message device 10 to a ground surface. This allows for the fasteners to only be accessible by the removal of the base access panel 74 (see below). Temporarily anchoring the assembly 10 further prevents sliding of the portable message device 10 and reduces potential theft and damage during extended use, while still providing portability. First and second wheels 66, 68 are therefore only operational during manual transportation of portable message device 10.

Base 12 includes a base access panel 74 which is fastened to base rear wall 60. Fasteners 76 are provided to securely attach the base access panel 74 to base rear wall 60 in a closed position shown. Fasteners 76 can be any suitable type of fastener for this purpose including tamper proof screws or bolts. A post access door 80 is also provided with post member 14. Post access door 80 is rotatably connected using a hinge 82 to the post member 14. A lock 84, such as a key lock operating a rotating arm, can be provided to lock the post access door 80 in the closed position shown. The post access door 80 in its closed position directly contacts a post rear wall 86. Also extending from the post rear wall 86 is a handle 88 located proximate to an upper end of post member 14. Handle 88 is provided to allow tipping of portable message device 10 away from the upright position shown until the first and second wheels 66, 68 contact the ground surface, allowing movement of portable message device 10.

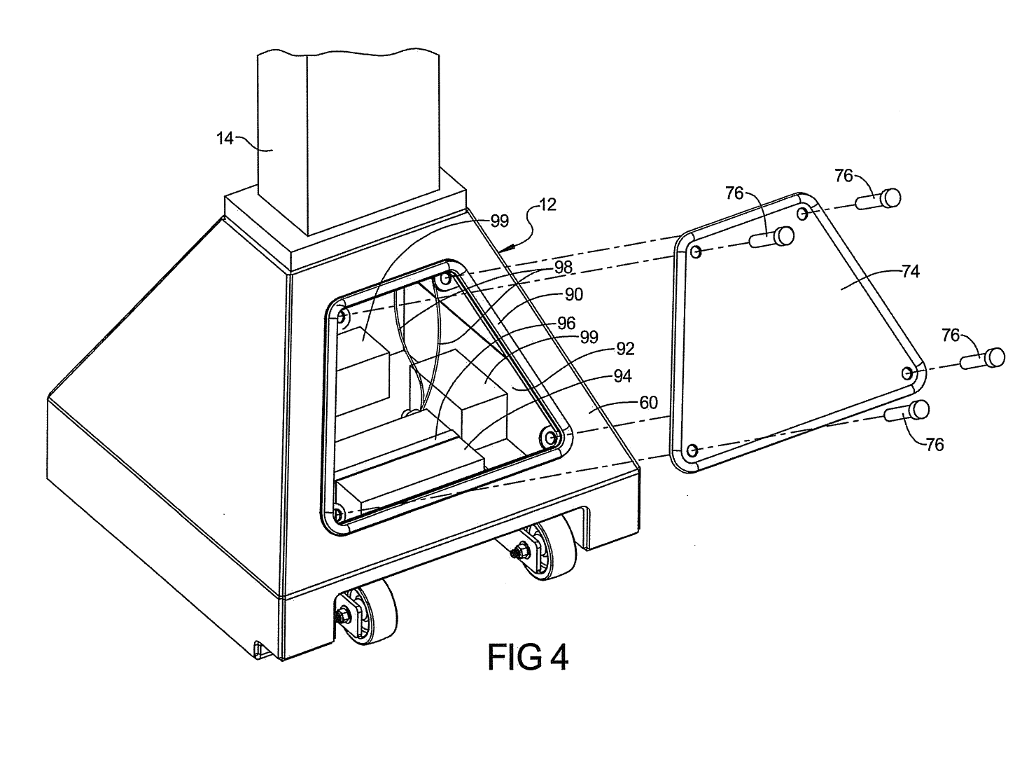

Referring to FIG. 4 and again to FIG. 3, the base access panel 74 is shown in an open position following removal of tamper proof fasteners 76. In order to seal the base access panel 74 from weather when in contact with the base rear wall 60, a panel seal 90 can be affixed to base wall 60 about the outer perimeter of the opening for the base access panel 74. The panel/seal 90 can be made of materials such as polymeric foam or a rubber material. With the base access panel 74 removed, a base cavity 92 is accessible. Base cavity 92 is sized to receive multiple components including a power source 94. According to several aspects, power source 94 is a deep-cycle battery, such as a 12-volt DC marine battery positioned substantially within the base cavity 92. For example, terminals of power source 94 may extend beyond the base cavity 92, but still position the center of gravity of the portable message device 10 low. Power source 94 is retained in position using a universal battery bracket or strap 96 made of plastic, rubber, metal or similar material used to restrain power source 94 during movement of portable message device 10. A plurality of power wires 98 are connected to power source 94 which extend through the services aperture 36 previously described in reference to FIG. 2.

One benefit of providing the power source 94 positioned substantially within the base cavity 92 is that the entire weight of the power source 94 is positioned to lower a center of gravity of portable message device 10 compared to comparable sign assemblies having their power units positioned either in a post or sign frame area. Other electrical components which are used for recharging power source 94 can also be provided in base cavity 92 such as a voltage conditioner. The weight of power source 94, particularly when a deep-cycle, 12-volt battery is used, obviates the need for adding material, such as water or sand, to base cavity 92. Elimination of water within base cavity 92 provides the obvious benefit of removing material which is susceptible to low-operating temperatures below freezing temperatures.

With continuing reference to FIG. 4, in addition to the weight provided by the power source 94, additional removable weights 99 can be positioned within the internal cavity 92 around or near the power source 94. Such removable weights 99 can include sand bags, either rigid or flexible containers having a fluid such as water (including an anti-freeze solution as required), lead or other dense metal weights, and the like. Use of removable weights 99 allows a total weight of the portable message device to be varied depending on service, anticipated wind loading, ease of movement and distance moved, and the like. Use of removable weights 99 also further lowers the center of gravity of the portable message device 10. In addition, the ease of removal of removable weights 99 allows the power source 94 to be readily accessed for charging operations, removal and/or replacement.

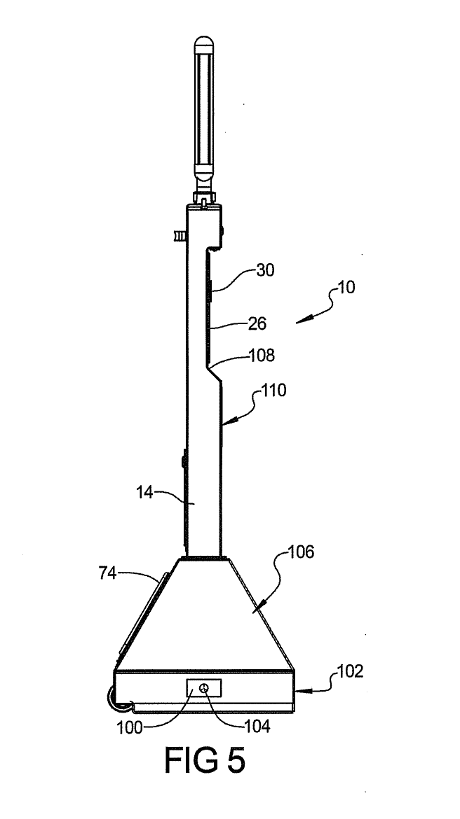

Referring to FIG. 5 and again to FIG. 1 and FIG. 4, a power conditioner/recharging panel 100 can be provided on a base left edge 102 as shown. Recharging panel 100 can include a charging connector 104 which allows for recharging of power source 94 without removal or opening of base access panel 74. This provides for recharging without breaking the weather-resistant seal provided by door seal 90, while providing exterior access for example for connection of a power cord. It is noted that the recharging panel 100 can be located at substantially any position on portable message device 10, including at substantially any position of base 12 including on base access panel 74. Any location on an exterior wall of base 12 is also acceptable for the position of recharging panel 100, including on a base left wall 106. The battery low indicator light 27, located in the post cavity 46 for ease of viewing, may indicate when power source 94 requires recharging.

In order to provide limited exposure to elements such as rain for components on removable panel 26, such as the actuation switch 30 and speaker 28, the removable panel 26 is positioned in a post recess area 108 which is inwardly directed with respect to a post front wall 110. Direct vertical impingement by rain or snow with actuation switch 30 and speaker 28 is therefore limited by the use of post recess area 108.

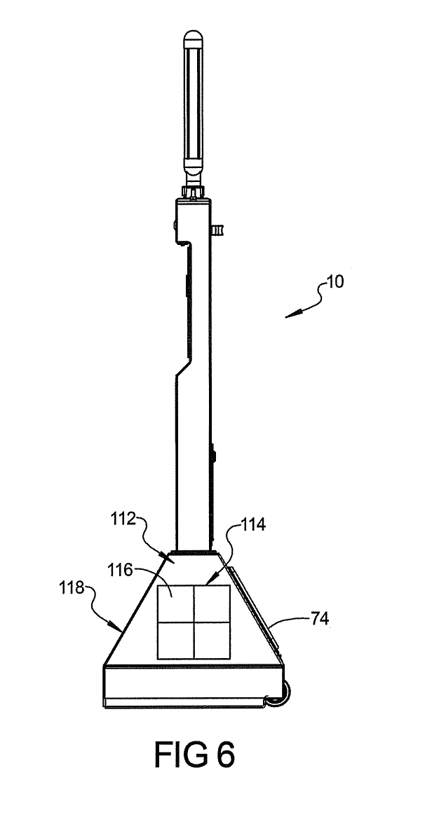

Referring to FIG. 6 and again to FIGS. 4-5, in addition to or in place of the use of the charging connector 104, the base right wall 112 provides an exemplary location for an array 114 providing one or more solar panels 116. The solar panels 116 can be used to recharge power source 94 either in place of or in addition to the use of charging connector 104. The angular faces of the exemplary pyramid-shaped base 12 are suited for receiving solar energy at various times of the day, therefore the geometry of the base 12 provides additional benefit of optimizing an orientation of the one or more arrays 114. Solar panels 116 are therefore beneficial in areas where a power source is otherwise not available for recharging power source 94. To best provide exposure to solar energy, an array similar to array 114 can be provided on any or all of the surfaces of base 12, including base front wall 118, on surfaces of the post member 14, and on a rear face of the sign frame/sign screen 18.

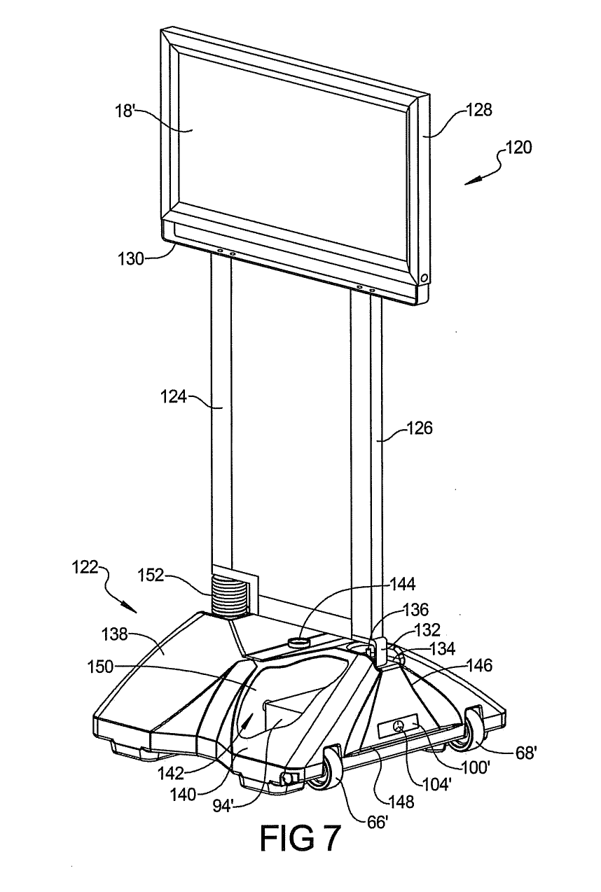

Referring to FIG. 7, according to additional aspects, a portable message device 120 provides several features which are modified from portable message device 10. Portable message device 120 includes a base 122 made of a polymeric material in a molding operation such that a complex geometry or multiple-faceted wall structure of base 122 can be provided. Each of a first support post 124 and a second support post 126 are connected to base 122 and extend vertically upright therefrom. A sign frame/sign screen 128 is connected to the first and second support posts 124, 126 using a sign mounting unit 130. Each of the first and second support posts 124, 126 can be connected to base 122 using individual support post brackets 132 which are positioned in individual mounting cavities 134 on opposite sides of base 122. Fasteners 136 are used to releasably connect the support post brackets 132 to the base 122.

Base 122 is divisible into each of a first base portion 138 and a second base portion 140, which are sealed to be weather-resistant and divided from each other using a divider wall 142. This permits the first base portion 138 to receive a known commodity, such as sand or water, to lower a center of gravity of portable message device 120. First base portion 138 can receive fill material through a fill port/cap 144. The second base portion 140 includes a base access door 146 which functions similar to base access panel 74 of portable message device 10. Base access panel 146 is removably connected to base 122 by way of tamper proof fasteners 76 as noted above. It should be appreciated that base access panel 146 (or 74) could also be a door that is connected to base 122 using a hinge and could be provided with a lock for security purposes. The second base portion 140 provides a second base portion cavity 150 accessible by opening base access door 146. Components similar to those provided in base 12 can be provided in second base portion cavity 150 including, but not limited to, a power source 94′. In addition, components such as a recharging panel 100′ can be connected to the second base portion 140, including direct connection to base access door 146. First and second wheels 66′, 68′ are similarly rotatably connected to base 122 to provide for portability of base 122. According to additional aspects, a coil spring 152 (only a single example of which is shown) can be used to connect the individual first and second support posts 124, 126 to base 122. Coil springs 152 allow the first and second support posts 124, 126 in addition to sign frame 128 to deflect during high-wind events, reducing the amount of weight required to maintain the position of base 122.

The portable message devices of the present disclosure provide communication feature 16 which can include providing sign information. The communication feature 16 can further include sound requirements including: the directional speaker so sound can be heard up to 15 feet away from the portable message in all directions; a volume control; ambient noise detection that automatically adjusts volume of the speaker to overcome the ambient noise level. The communication feature 16 can also include voice/message requirements including: a length of recording time that depends on a capacity of memory 49, which can be recorded on-site, and power source 94 (therefore providing ease of changing the message for each portable message device without the limitations of a pre-recorded message); a computer synthesized voice; messages can be input using a portable computer such as a laptop computer, a cell phone using a wireless system, USB connection, Bluetooth®, or smart phone; a security system is provided preventing unauthorized access to the message; the message is available in multiple languages, including English, Spanish, and others; and a warning sound is generated at the start and end of the message.

The portable message devices of the present disclosure include activation requirements including: a dip switch allowing operation by either a motion detector or continuous operation; when in motion detector mode the sensor will detect people (e.g., a pedestrian) at a distance up to approximately 15 feet away from the portable message device; a push button activation switch 30 is provided; a locator tone is provided; and the push button activation switch 30 is located at a predetermined height meeting ADA standards (i.e., 42 inches above ground level). The portable message devices of the present disclosure include mounting requirements including: a modular mounting assembly allowing connection to multiple different message and/or sign systems or a type IV sidewalk barricade; bolt holes are provided for locating the type IV barricade at a predetermined height; the message and/or sign portion of the portable sign can tilt and/or rotate to be directed toward pedestrian traffic.

The portable message devices of the present disclosure satisfy power requirements including: a DC multi-cell battery having extended battery life; solar power capability; recharging connections for the battery; the power source is portable such that a person can carry the power source to the portable message device and locally connect the power source; a battery low power indicator is provided; although a large combination of run times at maximum and nominal power usages can be realized depending on the size and type of battery or other power source used, as one example the power source can be sized to operate for a minimum run time of 30 hours at a maximum power usage rate, and a run time of 80 hours at a nominal power usage rate thereby providing operation for a weekend period; a light is provided for visibility; and all internal components are protected by weather-resistant seals.

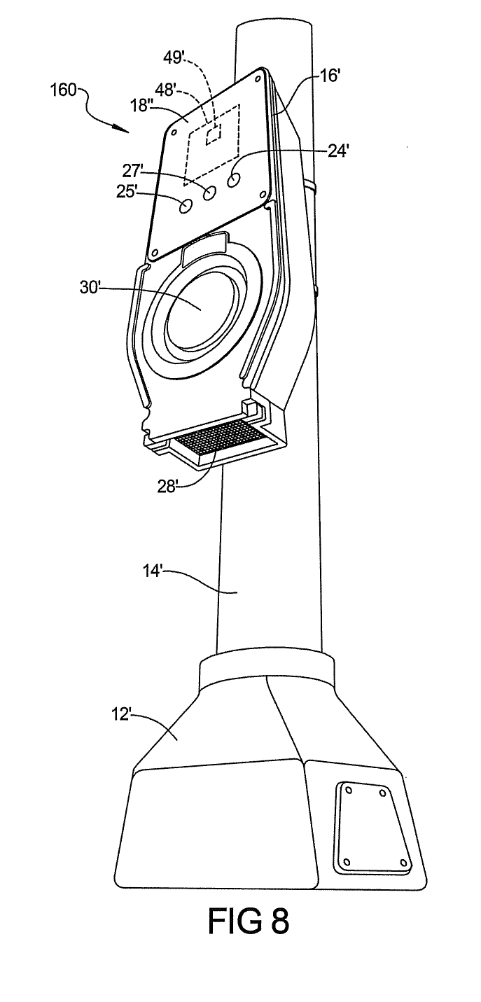

Referring to FIG. 8, according to additional aspects, a portable message device 160 provides several features which are modified from portable message device 10. Portable message device 160 includes a base 12′ which supports a post member 14′. At least one communication feature 16′ is provided with portable message device 160. According to several aspects, communication feature 16′ includes a message portion 18″. Messages, such as instructions for pedestrian crosswalks, hazardous area conditions, and the like, can be audibly presented by message portion 18″. Message portion 18″ can also include a fixed or permanent sign at the user's discretion. Communication feature 16′ is connected externally to and independently of post member 14′ using a typical sign mounting unit, such as a clamp, which further improves the modularity of communication feature 16′. Like previous aspects above, a power source is positioned substantially within the base 12′ to lower a center of gravity of portable message device 160.

Communication feature 16′ provides space for components such as an electronic processor 48′ used to control the operation of sign screen 18″. Processor 48′ is connected to the various components, such as sensor 24′, microphone 28′, and actuation switch 30′, as well as the message portion 18″. Processor 48′ therefore receives signals from the sensor 24′ and/or the actuation switch 30′ and provides output for the message portion 18″ including a speaker (not shown), flashing lights (not shown), or the like. An on-site recorded message can be saved in a memory 49′ which is also in communication with processor 48′. A card or circuit board containing processor 48′ and memory 49′ can be located at any location, including external of the base 12′, such as in the communication feature 16′. The card or circuit board can beneficially be located within a portion of the communication feature 16′ accessible by opening an access door on any surface of the communication feature 16′.

Communication feature 16′ can further provide space for ambient light sensor 25′, and battery low indicator light 27′. The lights may be of many types, but LED lights are preferred. The ambient light sensor 25′ detects when ambient light near the portable message device 160 is below a threshold. The ambient light sensor 25′ may then signal lights to turn on to ease viewing and operation by a person approaching portable message device 160. The battery low indicator light 27′ may indicate when more power may be required.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A portable message device, comprising:
a base;
a communication feature requiring electrical power; and
a power source positioned substantially within the base providing electrical power to operate the communication feature.

2. The portable message device of claim 1, wherein the communication feature defines a sign frame/sign screen, the sign frame/sign screen supported by the base.

3. The portable message device of claim 1, further including a controller and a memory.

4. The portable message device of claim 3, wherein the memory is configured to accept a message from an input.

5. The portable message device of claim 1, further comprising at least one sensor.

6. The portable message device of claim 5, wherein the at least one sensor is a light sensor.

7. The portable message device of claim 6, wherein the light sensor activates a light configured to illuminate at least a portion of the communication feature.

8. The portable message device of claim 5, wherein the at least one sensor is a proximity sensor.

9. The portable message device of claim 5, wherein the at least one sensor activates the communication feature.

10. The portable message device of claim 9, wherein the at least one sensor is a switch that plays a message from a memory.

11. The portable message device of claim 5, wherein the at least one sensor is an ambient noise microphone.

12. The portable message device of claim 1, further comprising an indicator light.

13. The portable message device of claim 12 wherein the indicator light indicates a level of electrical power of the power source.

14. The portable message device of claim 1, wherein the base has at least three edges that have a height of at least 2 inches.

15. A portable message device, comprising:
a base;
a message feature; and
a power source positioned to maximally lower a center of gravity of the portable message device and to operate the message feature.

16. The portable message device of claim 15, wherein the message feature further comprises memory.

17. The portable message device of claim 15, further comprising an interactive portion.

18. The portable message device of claim 17, wherein the interactive portion comprises a switch in communication with the message feature.

19. The portable message device of claim 18, wherein the interactive portion is configured to receive and store a message.

20. The portable message device of claim 19, wherein the switch is configured to play the message.

21. A portable message device, comprising:
a base having at least one wheel providing portability for the portable message device, and a base access panel which in an open position provides access to an internal base cavity;
a communication feature including a message portion providing a predetermined message saved in a memory;
a processor connected to the memory, the processor actuating the communication feature; and
a power source positioned substantially within the internal base cavity providing electrical power to operate the communication feature, the power source accessible by removing the base access panel.
